(19) United States
(12) Patent Application Publication
(10) Pub. No.: US 2009/0026926 A1
(43) Pub. Date: Jan. 29, 2009

(54) TRANSPARENT CONDUCTIVE FILM AND DISPERSION-TYPE ELECTROLUMINESCENCE DEVICE USING SAID FILM

(75) Inventors: Masashi Shirata, Kanagawa (JP); Katsuhide Manabe, Aichi (JP); Katsutoshi Inagaki, Aichi (JP)

Correspondence Address: SUGHRUE-265550, 2100 PENNSYLVANIA AVE. NW, WASHINGTON, DC, 20037-3213, US

(73) Assignees: FUJIFILM CORPORATION, Tokyo (JP); KITAGAWA INDUSTRIES CO., LTD., Nagoya-shi (JP)

(21) Appl. No.: 11/994,209

(22) PCT Filed: Jun. 30, 2006
(86) PCT No.: PCT/JP2006/313129

§ 371 Date: Dec. 28, 2007

(30) Foreign Application Priority Data
Jun. 30, 2005 (JP) 2005-192448

(51) Int. Cl. H01J 1/62; B32B 27/00

(52) U.S. Cl. 313/504; 428/411.1; 428/339

(57) ABSTRACT

To provide a low-resistance transparent conductive film with high light transmittance, which is a transparent conductive film including a transparent polymer film having on one surface thereof a transparent thin film layer with conductivity and a blocking layer containing at least one material selected from the group consisting of a thermoplastic resin, a thermosetting resin and a UV-curable resin on the thin film, which is characterized in: that a surface resistivity of the transparent thin film layer with conductivity is 0.1Ω/□ or more and not more than 100Ω/□; and that a refractive index of the material constituting the blocking layer is 1.6 or more and less than 1.9, and a dispersion-type EL device with high luminance and long life using the same.

### TECHNICAL FIELD

The present invention relates to a low-resistance transparent conductive film with high light transmittance and to a dispersion-type electroluminescence (EL) device with high luminance and long life using the same.

### BACKGROUND ART

An EL phosphor is a voltage excitation-type phosphor, and a dispersion-type EL device and a thin film-type EL device are known as a light-emitting device having an EL phosphor powder interposed between electrodes. A general form of the dispersion-type EL phosphor device is constructed of a structure in which a phosphor layer having an EL phosphor powder dispersed in a binder with dielectric constant is interposed between two electrodes, at least one of which is transparent, and the phosphor layer emits light upon application with an alternating current field between the both electrodes. The dispersion-type EL device prepared by using an EL phosphor powder can be processed so as to have a thickness of not more than several mm, is a surface light emitter and involves a number of advantages, such as low heat generation and good luminous efficiency. Accordingly, this EL device is expected to have such applications as for road signs, illuminations for various interiors and exteriors, light sources for flat panel displays such as liquid crystal displays and illumination light sources for the large-area advertisement.

But, the light-emitting device prepared by using a phosphor powder involves drawbacks such as low emission luminance and short emission life in comparison with light-emitting devices based on other principle. For that reason, various improvements have hitherto been attempted.

As the foregoing transparent electrode for EL device, ones prepared by fabricating tin-doped indium oxide (ITO) as a transparent conductive material on a polyethylene terephthalate (PET) film by means of sputtering or the like are generally used. In the inside of the EL device, reflection to be caused due to a difference in refractive index at an interface between the ITO surface and the phosphor layer is generated, and the emission luminance (light extraction efficiency) of the EL device is lowered. As a method for reducing the reflectance on the ITO surface, a method for fabricating a low-refractive index transparent thin film having a refractive index of not more than 1.6 on ITO is disclosed (Patent Document 1). However, a low-resistance ITO film of not more than 100Ω/□ which is used especially in the case of preparing a large-area EL device involved a problem that the reflection is large, resulting in a large reduction of the emission luminance of the EL device.

On the other hand, in general, as one of causes of deterioration of the EL device, it is known that the interface at which the phosphor layer and the transparent electrode come into contact with each other is deteriorated due to heat, oxygen or the like, resulting in blackening on the light-emitting surface. In order to solve this, it is disclosed that a high-dielectric constant resin layer having a palladium fine powder dispersed therein is provided between the phosphor layer and the transparent electrode (Patent Document 2). Also, as to the separation between the phosphor layer and the transparent electrode, which is generally known as other cause of the deterioration, some measures for improving the adhesiveness are disclosed (Patent Documents 3 and 4).

Patent Document 1: JP-A-7-257945

Patent Document 2: JP-A-5-325645

Patent Document 3: JP-A-8-288066

Patent Document 4: JP-A-10-134963

### DISCLOSURE OF THE INVENTION

### Problems that the Invention is to Solve

However, these methods involved a problem that not only the emission luminance of the EL device can be enhanced, but when for the purpose of enhancing the emission luminance, it is intended to achieve high-frequency, high-voltage drive (for example, drive at a frequency of 800 Hz or a voltage of 100 V or more), the durability of the device becomes worse.

Accordingly, an object of the invention is to provide a low-resistance transparent conductive film with high light transmittance and a dispersion-type EL device with high luminance and long life using the same.

### Means for Solving the Problems

The invention is as follows.

(1) A transparent conductive film including a transparent polymer film having on one surface thereof a transparent thin film layer with conductivity and a blocking layer containing at least one material selected from the group consisting of a thermoplastic resin, a thermosetting resin and a UV-curable resin on the thin film, which is characterized in:

that a surface resistivity of the transparent thin film layer with conductivity is 0.1Ω/□ or more and not more than 100Ω/□; and that a refractive index of the material constituting the blocking layer is 1.6 or more and less than 1.9.

(2) The transparent conductive film as set forth above in (1), which is characterized in that a thickness of the blocking layer is 0.01 μm or more and less than 1.5 μm.
(3) The transparent conductive film as set forth above in (1) or (2), which is characterized in that a surface resistivity of the transparent thin film layer with conductivity is 1Ω/□ or more and not more than 85Ω/□.
(4) A dispersion-type electroluminescence device including at least a phosphor layer between a transparent conductive film and a back electrode, which is characterized in that the transparent conductive film is the transparent conductive film as set forth above in any one of (1) to (3).

### ADVANTAGES OF THE INVENTION

According to the invention, it is possible to provide a low-resistance transparent conductive film with high light transmittance. Furthermore, a dispersion-type EL device using the foregoing transparent conductive film (this dispersion-type EL device will be referred to as “EL device”) is able to realize large screen size, has excellent emission excellent luminance and durability and has long life.

### BEST MODES FOR CARRYING OUT THE INVENTION

The invention is hereunder described in more detail.

The transparent conductive film of the invention is one including a transparent polymer film having thereon a transparent thin film layer with conductivity (hereinafter simply referred to as “transparent thin film layer”) (in this description, a stack having a transparent thin film layer with conductivity on a transparent polymer film will be often referred to as “transparent conductive substrates”) and further having on the transparent thin film a blocking layer containing at least one material selected from the group consisting of a thermoplastic resin, a thermosetting resin and a UV-curable resin.

### <Transparent Conductive Substrate>

The transparent conductive substrate is obtainable by entirely depositing and fabricating a transparent conductive material such as indium tin oxide, tin oxide, antimony-doped tin oxide, zinc-doped tin oxide and zinc oxide (all having a refractive index of from about 1.9 to 2.0) on a transparent polymer film made of a polyethylene terephthalate or triacetyl cellulose base or the like by a method inclusive of vapor deposition, coating and printing.

Also, a multilayered structure in which a silver thin film is sandwiched by high-refractive index layers may be employed. Furthermore, a conductive polymer such as conjugated high-molecular weight materials inclusive of polyaniline and polypyrrole can also be preferably used.

These transparent conductive materials are described in Denjiha-shirudo Zairyo No Genjo To Shorai (Existing State and Future of Electromagnetic Shielding Materials), issued by Toray Research Center, Inc., JP-A-9-147639 and so on.

Also, as the foregoing transparent conductive substrate, it is preferable to use a transparent conductive sheet obtained by depositing and fabricating the foregoing transparent conductive material on the foregoing transparent polymer film; or a transparent conductive sheet obtained by preparing a conductive surface in which a thin line structural part of a metal and/or an alloy of a uniform network, a comb type or a grid type or others is disposed on a conductive polymer, thereby improving the conductivity.

In the invention, a surface resistivity of the transparent thin film layer is 0.1Ω/□ or more and not more than 100Ω/□, more preferably 1Ω/□ or more and not more than 85Ω/□, and especially preferably 5Ω/□ or more and not more than 80Ω/□. The surface resistivity of the transparent thin film layer is a value as measured in conformity with the measurement method as described in JIS K6911.

### <Blocking Layer>

The transparent conductive film of the invention is largely characterized in that it has at least one blocking layer containing at least one material selected from the group consisting of a thermoplastic resin, a thermosetting resin and a UV-curable resin on the foregoing transparent thin film layer and that a refractive index of the material constituting the blocking layer is 1.6 or more and less than 1.9. The refractive index of the material constituting the blocking layer is more preferably 1.65 or more and not more than 1.85, and especially preferably 1.70 or more and not more than 1.80.

The present inventor has found out that the light transmittance of the transparent conductive film is enhanced by the foregoing blocking layer and that in applying this film to an EL device, enhancement in luminance of the EL device by a reduction of the reflection to be caused due to a difference in refractive index between the transparent thin film layer and the phosphor layer and realization of long life (enhancement in durability) of the EL device by a reduction of the deterioration at the interface between the transparent thin film layer and the phosphor layer can be simultaneously achieved.

A thickness of the blocking layer is preferably 0.01 μm or more and less than 1.5 μm, more preferably 0.02 μm or more and legs than 1.2 μm, and especially preferably 0.05 μm or more and less than 1.0 μm. Sufficient reflection-reducing effect and durability-enhancing effect are obtainable within the foregoing range. In the case where the thickness of the blocking layer is less than 0.01 μm, though an electric field is effectively applied to a phosphor particle, whereby a reduction of the initial luminance is small, the reflection-reducing and durability-enhancing effects are low; and in the case where it is 1.5 μm or more, though the durability-enhancing effect is revealed, the initial luminance is low, and therefore, such is not preferable.

As the material constituting the blocking layer, any material is useful so far as it is a material selected from the group consisting of a thermoplastic resin, a thermosetting resin and a UV-curable resin and having a refractive index of 1.6 or more and less than 1.9. As the thermoplastic resin, for example, polystyrene (refractive index: up to 1.62), polyvinylidene chloride (refractive index: 1.60 to 1.63) and polyethylene terephthalate (refractive index: 1.65) are suitably used; as the thermosetting resin, a phenol-formaldehyde resin (refractive index: up to 1.7), an epoxy resin (refractive index: 1.61) and the like are suitably used; as the UV-curable resin, a polyfunctional acrylic ester compound and the like are exemplified; and it is also preferable that the thermosetting resin is mixed with the UV-curable resin. The organic polymer compound of the blocking layer to be used may be either an insulator or a conductor. In particular, it is preferable that the blocking layer contains at least one organic polymer compound having a high softening point, concretely the softening point being preferably 120° C. or higher, more preferably 140° C. or higher, and most preferably 170° C. or higher. By setting up the softening point at 120° C. or higher, even when the thickness of the blocking layer is thinner, the durability-enhancing effect can be obtained.

As to these softening points, glass transition points as described in, for example, Chapter VI of Polymer Handbook, Third Edition, published by Wiley-Interscience can be made by reference.

Of these, examples of those which have a high softening point and are preferable include a polyester composed of bisphenol A, terephthalic acid and isophthalic acid (U POLYMER U-100, manufactured by Unitika, Ltd.) and a polyester composed of 4,4′-(3,3,5-trimethylcyclohexylidene)bisphenol, bis-phenol A, terephthalic acid and isophthalic acid.

In the foregoing blocking layer, the foregoing organic polymer compound is preferably used in a proportion of 20% or more, more preferably 50% or more, and most preferably 70% or more in terms of a volume ratio (proportion in the solids of the blocking layer) in the constitutional materials of the blocking layer. By this, the effects of the blocking layer of the invention can be more effectively exhibited. As the refractive index of the blocking layer which is constituted of plural materials, a numerical value obtained by allotting refractive indexes of the respective materials according to a volume ratio is employed. For example, in the case where the blocking layer is composed of a material having a refractive index of 1.5 in a volume ratio of 20% and a material having a refractive index of 1.2 in a volume ratio of 80%, the refractive index of the blocking layer is 1.5×0.2+1.2×0.8=1.26.

As other compounds which the blocking layer may contain, there are specifically exemplified particles of a metal simple substance, a metal oxide, a metal chloride, a metal nitride, a metal sulfide or the like. Such a compound can be contained within the range where the transparency is not substantially impaired. Examples thereof include particles of Au, Ag, Pd, Pt, Ir, Rh, Ru, Cu, SnO₂, In₂O₃, Sn-doped In₂O₃, TiO₂, BaTiO₃, SrTiO₃, Y₂O₃, Al₂O₃, ZrO₂, PdCl₂, AlON, ZnS or the like; and particles of silica gel or alumina. Also, other organic polymer compounds can be used without particular limitations. The terms “substantially transparent” as referred to herein mean that transmittances as measured at 450 nm, 550 nm and 610 nm are all 50% or more. Also, a dye, a fluorescent dye, a fluorescent pigment, a transparent organic particle or a light emitter particle in an extent that the effects of the invention are not lost (not more than 30% of the luminance of the whole of the EL device) may be made to exist.

The blocking layer can be formed by dissolving such an organic polymer compound or a precursor thereof in an appropriate organic solvent (for example, dichloromethane, chloroform, acetone, methyl ethyl ketone, cyclohexanone, acetonitrile, dimethylformamide, dimethylacetamide, dimethyl sulfoxide, toluene, xylene and N-methylpyrrolidone) and coating the solution on the transparent thin film layer or the phosphor layer.

Also, the blocking layer is preferably one which is constituted of a combination of an inorganic compound and an organic polymer compound so far as the refractive index falls within the foregoing range. Examples of the inorganic compound include a metal simple substance, silicon dioxide and besides, a metal oxide and a metal nitride. As to the blocking layer, a thin film layer of an inorganic compound may be formed, and as a formation method thereof, a sputtering method, a CVD method and the like can be employed.

Not only the blocking layer reduces the reflection, but since the blocking layer blocks the contact between a phosphor particle and a transparent thin film layer, it brings an effect for remarkably inhibiting the deterioration at the interface between the phosphor particle and the transparent thin film layer, which is caused when a voltage is applied and light emission is continued for a long period of time. As a result, the blocking layer achieves high durability while maintaining high luminance and high efficiency. In particular, high durability can be achieved under a high-luminance light emission condition (frequency: 800 Hz or more, voltage; 100 V or more).

For the purposes of enhancing the luminance and realizing white light emission, it is preferable that the transparent conductive film of the invention preferably transmits 80% or more, and more preferably 90% or more of light in a wavelength region of from 420 nm to 650 nm. For the purpose of realizing white light emission, it is more preferable that the transparent conductive film transmits light in a wavelength region of from 380 nm to 680 nm. The light transmittance of the transparent conductive film can be measured by a spectrophotometer.

### <Phosphor Layer>

The EL device of the invention has a structure in which at least a phosphor layer is interposed between the foregoing transparent conductive film (hereinafter also referred to as “transparent electrode”) and a back electrode.

The phosphor layer can be formed by dispersing a phosphor particle powder in an organic binder having a refractive index of 1.40 or more and less than 1.6 and coating the dispersion.

As the foregoing organic binder, a raw material with high dielectric constant is desirable, and examples thereof include a polymer compound containing, as a polymerization unit, trifluoromonochloroethylene (refractive index: 1.425), vinylidene fluoride (refractive index: 1.42) or the like; a cyanoethyl cellulose based resin (refractive index: about 1.49); and polyvinyl alcohol (refractive index: about 1.5). It is preferable that the whole or a part thereof is contained. Above all, the cyanoethyl cellulose based resin is suitably used because its dielectric constant is high.

As to a blending proportion of such an organic binder and the foregoing phosphor particle, the content of the foregoing phosphor particle in the phosphor layer relative to the whole of solids is preferably a proportion of from 30 to 90% by mass, and more preferably a proportion of from 60 to 85% by mass. By this, the surface of the phosphor layer can be made smooth.

As the organic binder, the cyanoethyl cellulose based resin is preferably used in a proportion of 20% or more, and more preferably 50% or more in terms of a mass ratio relative to the whole of the phosphor layer.

A thickness of the thus obtained phosphor layer is preferably 30 μm or more and less than 60 μm, and more preferably 35 μm or more and less than 45 μm. When the thickness of the phosphor layer is 30 μm or more, good smoothness of the surface of the phosphor layer can be obtained; and when it is less than 50 μm, an electric field can be effectively applied to the phosphor particle, and therefore, such is preferable.

### <Phosphor Particle>

Concretely, the phosphor particle which is preferably used in the invention is a particle of a semiconductor composed of one or plural elements selected from the group consisting of an element of the group II and an element of the group VI and one or plural elements selected from the group consisting of an element of the group III and an element of the group V and is arbitrarily chosen depending upon a necessary light emission wavelength region. Examples thereof include CdS, CdSe, CdTe, ZnS, ZnSe, ZnTe, CaS, SrS, GaP and CaAs. Of these, ZnS, CdS, CaS and the like are preferably used.

The phosphor particle in the invention can be formed by a baking method (solid phase method) which is widely employed in the field. For example, in case of zinc sulfide, a fine particle powder of from 10 nm to 50 nm (usually namely as “raw powder”) is prepared by a liquid phase method and used as a primary particle, namely a matrix substance. The zinc chloride includes two crystal systems of a high-temperature stable hexagonal system and a low-temperature stable cubic system. Any of these systems may be employed, and a mixture of these systems may also be employed. This is baked together with an impurity which is called as an activator or a co-activator and a flux in a crucible at a high temperature of from 900° C. to 1,300° C. for from 30 minutes to 10 hours, thereby obtaining an intermediate phosphor particle. A backing temperature for obtaining a phosphor particle with preferable size and low coefficient of variation is preferably from 950° C. to 1,250° C., and more preferably from 1,000° C. to 1,200° C. Also, a baking time is preferably from 30 minutes to 6 hours, and more preferably from 1 hour to 4 hours. Also, the flux is preferably used in a proportion of 40% by mass or more, more preferably 50% by mass or more, and further preferably 55% by mass or more. Here, the proportion of the flux is expressed by: [proportion of flux (% by mass)]=(mass of flux)/[(mass of primary particle of raw material phosphor)+(mass of flux)]. For example, in the case where copper as an activator is previously mixed in the raw powder as in a copper-activated zinc sulfide phosphor, copper as an activator is also integrated with the phosphor raw material powder, and in that case, the mass of the raw material phosphor including copper is weighed.

As to the flux, there may be the case where the mass at room temperature differs from the mass at the baking temperature. For example, though barium chloride is present in a state of BaCl₂2.H₂O at room temperature, it is thought that barium chloride looses water of hydration and becomes BaCl₂ at the baking temperature. But, the proportion of the flux as referred to herein is calculated on the basis of the mass of the flux in a stable state at room temperature.

Furthermore, in the invention, it is preferable to achieve washing with ion exchanged water for the purpose of removing the excessive activator, co-activator and flux contained in the intermediate phosphor powder as obtained by the foregoing baking.

A spontaneously caused plane-like stacking fault (twin crystal structure) is present in the inside of the intermediate phosphor particle as obtained by baking. The density of the stacking fault can be largely increased without breaking the particle by further applying an impact force of a certain range. As a method for applying an impact force, there have hitherto been known a method in which the intermediate phosphor particles are brought into contact with each other and mixed; a method in which a sphere such as alumina is blended and mixed (for example, by a ball mill) or the particles are accelerated to collide; and the like. In particular, in case of zinc sulfide, two crystal systems of a cubic crystal system and a hexagonal crystal system exist. In the former, the closest atomic plane ((111) plane) forms a three-layer structure of ABCABC . . . ; and in the latter, the closest atomic plane perpendicular to the c-axis forms a two-layer structure of ABAB . . . . For that reason, when an impact is applied to the zinc sulfide crystal by a ball mill or the like, slippage of the closest atomic plane takes place in the cubic crystal system. If the C-plane comes out, the cubic system is partially transformed to a hexagonal system of ABAB, whereby edge-like dislocation may be possibly caused or the AB plane may be possibly reversed to produce a twin crystal. In general, since impurities in crystals are concentrated on a lattice defect region, when zinc sulfide having a stacking fault is heated to diffuse an activator such as copper sulfide, the activator is deposited in the stacking fault. Because the interface between the portion where the activator is deposited and the matrix zinc sulfide becomes a light emission center of the phosphor particle, it is also preferable in the invention that the density of the stacking fault is high for the purpose of enhancing the luminance.

Next, the resulting intermediate phosphor powder is subjected to second baking. The second baking is carried out by heating (annealing) at from 500° C. to 800° C., the temperature of which is lower than that in the first baking, for from 30 minutes to 3 hours, the time of which is shorter than that in the first baking. By this, the activator can be deposited intensively in the stacking fault.

Thereafter, the intermediate phosphor is etched with an acid such as hydrochloric acid to remove the metal oxide attached to the surface thereof, and copper sulfide attached to the surface thereof is further removed by washing with KCN or the like. Subsequently, drying is performed to obtain a phosphor particle.

It is preferable that the phosphor particle has a size of 1 μm or more and less than 20 μm and a coefficient of variation of 3% or more and less than 35%. By using the particle falling within the foregoing range, since the phosphor layer can be made sufficiently smooth, it is possible to obtain an EL device with high luminance and long life.

Also, examples of other methods for forming a phosphor include a vapor phase method, for example, a method of combination of fluidized oil surface vapor deposition with a laser ablation method, a CVD method, a plasma method and a sputtering, resistance-heating method or electron beam method; a liquid phase method, for example, a double decomposition method, a method by thermal decomposition reaction of a precursor, a reversed micelle method, a combination method of any of these methods with high-temperature baking and a freeze-drying method; a urea melting method; and a spray thermal decomposition method.

The average size and coefficient of variation of the phosphor particle of the invention can be measured by a method by laser scattering, for example, a laser diffraction, scattering-type particle size distribution analyzer, LA-920, manufactured by Horiba, Ltd. Here, the average particle size refers to a median size.

Also, it is preferable that the phosphor particle of the invention is zinc sulfide containing copper as an activator and further contains at least one kind of metal elements belongs to the second transition series of the group 6 to the group 10. Of these, molybdenum and platinum are preferable. Such a metal is preferably contained in zinc sulfide in a proportion in the range of from 1×10⁻⁷ mole to 1×10⁻³ mole, and more preferably from 1×10⁻⁶ mole to 5×10⁻⁴ moles per mole of zinc sulfide. It is preferable that such a metal is added in deionized water together with a zinc sulfide fine powder and a prescribed amount of copper sulfate to form a slurry, which is then well mixed and dried, and the resulting mixture is baked together with a co-activator and a flux and contained in the zinc sulfide particle. It is also preferable that a complex powder containing such a metal is mixed with a flux, and the mixture is baked together with a co-activator and a flux and contained in the zinc sulfide particle. In any of these cases, during the addition of the metal, an arbitrary compound containing a metal element can be used as a raw material compound, and more preferably, a complex in which oxygen or nitrogen is coordinated with a metal or a metal ion is used. The ligand may be either an inorganic compound or an organic compound. By this, it becomes possible to realize more enhancement of the luminance and long life.

It is more preferable that the phosphor particle has a non-light-emitting shell layer on the surface of the particle. In forming the shell layer, it is preferable to set up a thickness of the shell layer at 0.1 μm or more, and preferably 0.11 or more and not more than 1.0 μm by employing a chemical method following the preparation of a semiconductor fine particle which will become a core of the phosphor particle.

The non-light-emitting shell layer can be made of an oxide, a nitride or an oxynitride, or a substance having the same composition as those formed on the matrix phosphor particle but not containing a light emission center. Also, the non-light-emitting shell layer can be formed of a substance epitaxially grown on the matrix phosphor particle material and having a different composition.

Examples of a method for forming the non-light-emitting shell layer include a vapor phase method, for example, a method of combination of fluidized oil surface vapor deposition with a laser ablation method, a CVD method, a plasma method and a sputtering, resistance-heating or electron beam method; a liquid phase method, for example, a double decomposition method, a sol-gel method, an ultrasonic chemical method, a method by thermal decomposition reaction of a precursor, a reversed micelle method, a combination method of any of these methods with high-temperature baking, a urea melting method and a freeze-drying method; and a spray thermal decomposition method.

In particular, the urea melting method and the spray thermal decomposition method which are suitably used for the formation of the phosphor particle are also suitable for the synthesis of the non-light-emitting shell layer.

For example, in the case where a non-light-emitting shell layer is provided on the surface of the zinc sulfide phosphor particle, the zinc sulfide phosphor is added in a urea solution in which a metal salt which will become a material of the non-light-emitting shell layer is dissolved and melted. Since zinc sulfide is insoluble in urea, the temperature of the solution is raised in the same manner as in the case of the particle formation, thereby obtaining a solid in which the zinc sulfide phosphor and the non-light-emitting shell layer material are uniformly dispersed in a urea-derived resin. This solid is pulverized and then baked while thermally decomposing the resin in an electric furnace. The baking atmosphere is selected from an inert atmosphere, an oxidizing atmosphere, a reducing atmosphere, an ammonia atmosphere and a vacuum atmosphere, whereby a zinc sulfide phosphor particle having a non-light-emitting shell layer composed of an oxide, a sulfide or a nitride on the surface thereof can be synthesized.

Also, for example, in the case where a non-light-emitting shell layer is provided on the surface of the zinc sulfide phosphor particle by a spray thermal decomposition method, the zinc sulfide phosphor is added in a solution in which a metal salt which will become a material of the non-light-emitting shell layer is dissolved. When this solution is atomized and thermally decomposed, the non-light-emitting shell layer is formed on the surface of the zinc sulfide phosphor particle. By appropriately selecting an atmosphere of the thermal decomposition and an atmosphere of additional baking, a zinc sulfide phosphor particle having a non-light-emitting shell layer composed of an oxide, a sulfide or a nitride on the surface thereof can be synthesized.

### <Dielectric Layer>

A dielectric layer may be made of any material having high dielectric constant and insulating properties and having high dielectric breakdown voltage. The material is selected from metal oxides and metal nitrides. Examples thereof include BaTiO₃, KNbO₃, LiNb₃, LiTaO₃, Ta₂O₃, BaTa₂O₆, Y₂O₃, Al₂O₃ and AlON. Such a material may be provided as a homogeneous film or may be used as a film having a particle structure containing an organic binder. For example, as described in Mat. Res. Bull. Volume 36, page 1065, a film constituted of a BaTiO₃ fine particle and a BaTiO₃ sol is used.

Examples of the organic binder which can be used in the dielectric layer include polymers having a relatively high dielectric constant, for example, cyanoethyl cellulose based resins; polyethylene, polypropylene or polystyrene based resins, silicone resins; epoxy resins; and resins of a vinylidene fluoride. The dielectric constant can be adjusted by properly mixing a fine particle with high dielectric constant, for example, BaTiO₃ and SrTiO₃ in such a resin. As to the dispersing method, a homogenizer, a planetary kneader, a roll kneader, an ultrasonic dispersing machine or the like can be used.

### <Red Light-Emitting Material>

In the EL device of the invention, in addition to the above-exemplified zinc sulfide particle which emits bluish green light for the purpose of preparing white light emission, a red light-emitting material which emits red light can be used. The red light-emitting material may be dispersed in the phosphor layer or may be dispersed in the dielectric layer, and may be positioned between the phosphor layer and the transparent electrode or on an opposite side of the transparent electrode to the phosphor layer.

In the EL device of the invention, the red light emission wavelength at the time of white light emission is preferably 600 nm or more and not more than 650 nm. In order to obtain a red light emission wavelength falling within this range, it is the most preferable that the red light-emitting material is contained in the dielectric layer. As to the dielectric red light-emitting material-containing layer, though it is preferable that all of the dielectric layers in the EL device of the invention are a red light-emitting material-containing layer, it is more preferable that the dielectric layer in the EL device is divided into two or more, a part of which is a red light-emitting material-containing layer. It is preferable that the red light-emitting material-containing layer is positioned between a red light-emitting material-free dielectric layer and a phosphor layer; and it is also preferable that the red light-emitting material-containing layer is positioned such that it is sandwiched by a red light-emitting material-free dielectric layer from both sides thereof.

In the case where the red light-emitting material-containing layer is positioned between a red light-emitting material-free dielectric layer and a phosphor layer, the red light-emitting material-containing layer is preferably 1 μm or more and not more than 20 μm, and more preferably 3 μm or more and not more than 17 μm. A concentration of the red light-emitting material in the dielectric layer having a red light-emitting material added therein is preferably 1% by mass or more and not more than 20% by mass, and more preferably 3% by mass or more and not more than 15% by mass in terms of % by mass relative to the dielectric particle represented by BaTiO₃. In the case where the red light-emitting material-containing layer is positioned such that it is sandwiched by a red light-emitting material-free dielectric layer from both sides thereof, the red light-emitting material-containing layer is preferably 1 μm or more and not more than 20 μm, and more preferably 3 μm or more and not more than 10 μm. A concentration of the red light-emitting material in the dielectric layer having a red light-emitting material added therein is preferably 1% by mass or more and not more than 30% by mass, and more preferably 3% by mass or more and not more than 20% by mass in terms of % by mass relative to the dielectric particle. In the case where the red light-emitting material-containing layer is positioned such that it is sandwiched by a red light-emitting material-free dielectric layer from both sides thereof, it is also preferable that the red light-emitting material-containing layer is formed of only a binder with high dielectric constant and a red light-emitting material without containing a dielectric particle therein.

When the red light-emitting material as used herein is in a state of powder, the light emission wavelength is preferably 600 nm or more and not more than 750 nm, more preferably 610 nm or more and not more than 650 nm, and most preferably 610 nm or more and not more than 630 nm. When this light-emitting material is added in the EL device and EL light emission is performed, as described above, the light emission wavelength is preferably 600 nm or more and not more than 650 nm, more preferably 605 nm or more and not more than 630 nm, and most preferably 608 nm or more and not more than 620 nm.

As a binder of the red light-emitting material-containing layer, polymers having a relatively high dielectric constant, for example, cyanoethyl cellulose based resins; polyethylene, polypropylene or polystyrene based resins, silicone resins; epoxy resins; and resins of a vinylidene fluoride are preferable.

As the red light-emitting material of the invention, a fluorescent pigment or a fluorescent dye can be preferably used. As a compound which forms a light emission center of such a material, compounds having, as a skeleton, rhodamine, lactone, xanthene, quinoline, benzothiazole, triethyl-indoline, perylene, triphennine or dicyanomethylene are preferable. Besides, it is also preferable to use a cyanine based coloring matter, an azo dye, a polyphenylenevinylene based polymer, a disilane-oligothienylene based polymer, a ruthenium complex, a europium complex or an erbium complex. Such a compound may be used singly or in admixture of plural kinds thereof. Also, such a compound may be used after further dispersing in a polymer or the like.

### <Back Electrode>

The back electrode on the side from which light is not extracted may be made of any material with conductivity. The material is appropriately selected from metals such as gold, silver, platinum, copper, iron and aluminum, graphite and other materials depending upon the form of the device to be prepared, the temperature in preparation steps and the like. A transparent electrode such as ITO may be used so far as it has conductivity. Furthermore, from the viewpoint of enhancing the durability, it is important that a coefficient of thermal conductivity of the back electrode is high; and the coefficient of thermal conductivity is preferably 2.0 W/cm·deg or more, and especially preferably 2.5 W/cm·deg or more.

Also, in order to ensure high heat dissipation properties and energizing properties in the surroundings of the EL device, it is also preferable to use a metal sheet or a metal mesh as the back electrode.

### <Manufacturing Method of EL Device>

In the EL device of the invention, it is preferable to form each of the phosphor layer, the dielectric layer and the blocking layer by preparing a coating solution having the materials dissolved in a solvent and coating it by employing a spin coating method, a dip coating method, a bar coating method, a spray coating method or the like. In particular, it is preferable to employ a method which does not choose the printing surface, such as a screen printing method or a method capable of achieving continuous coating, such as a slide coating method. For example, according to the screen printing method, a dispersion of a phosphor particle or a dielectric material fine particle in a polymer solution with high dielectric constant is coated through a screen mesh. By choosing the mesh thickness, the opening or the coating frequency, the film thickness can be controlled. By changing the dispersion, not only the phosphor layer and the dielectric layer but the back electrode layer and the like can be formed; and furthermore, by changing the size of the screen, a large area can be easily realized.

Also, in order to enhance the adhesiveness between the phosphor layer and the blocking layer, it is preferable to previously coat the organic binder to be used in the phosphor layer (especially preferably a cyanoethyl cellulose based resin) on the surface of the blocking layer.

In the case of providing it for such coating, it is preferable to use a coating solution prepared by adding an appropriate organic solvent in constitutional materials of each of the phosphor layer, the dielectric layer and the blocking layer. Examples of the organic solvent which is preferably used include dichloromethane, chloroform, acetone, acetonitrile, methyl ethyl ketone, cyclohexanone, dimethylformamide, dimethylacetamide, dimethyl sulfoxide, toluene and xylene.

Also, a viscosity of the foregoing coating solution is preferably from 0.1 to 5 Pa·s, and especially preferably from 0.3 to 1.0 Pa·s. When the viscosity of the coating solution for forming a phosphor layer or the coating solution for forming a dielectric particle-containing dielectric layer is less than 0.1 Pa·s, unevenness in thickness of the coating film is easily generated, and the phosphor particle or the dielectric particle may be possibly separated and precipitated with a lapse of time after dispersing. On the other hand, when the viscosity of the coating solution for forming a phosphor layer or the coating solution for forming a dielectric layer exceeds 5 Pa·s, coating at a relatively high speed becomes difficult. The foregoing viscosity is a value as measured at 16° C., the temperature of which is the same as the coating temperature.

It is especially preferable that the phosphor layer is formed by performing continuous coating using a slide coater or an extrusion coater or the like such that a dry thickness of the coating film is 30 μm or more and less than 60 μm.

As to the foregoing respective layers, it is preferable that at least steps including from coating to drying are a continuous step. The drying step is classified into a constant-rate drying step until the coating film has been dried and solidified and a falling-rate drying step for reducing the residual solvent of the coating film. In the invention, in the case where a binder ratio of each layer is high, when the layer is rapidly dried, only the surface is dried, and a convection current is generated within the coating film, thereby easily causing so-called Benard cells; and a blister fault is easily generated due to abrupt expansion of the solvent, thereby remarkably impairing the uniformity of the coating film. Conversely, when a final drying temperature is low, the solvent remains within each of the functional layers, thereby affecting post-steps of forming an EL device, such as a lamination step of a moistureproof film. Accordingly, it is preferable that the drying step is carried out in such a manner that a constant-rate drying step is gently performed, whereas a falling-rate drying step is carried out at a temperature sufficient for drying the solvent. As a method for gently performing the constant-rate drying step, it is preferable that a drying chamber through which a support runs is divided into some zones and that the drying temperature after completion of the coating step is increased step by step.

### <Sealing Method>

It is preferable that the EL device of the invention is finally processed by using a sealing film so as to eliminate influences of the humidity and oxygen from the external atmosphere. A water vapor permeation rate at 40° C. and 90% RF of the sealing film for sealing the EL device is preferably not more than 0.1 g/m²/day, and more preferably not more than 0.05 g/m²/day. Furthermore, an oxygen permeation rate at 40° C. and 90% RH of the sealing film is preferably not more than 0.1 cm³/m²/day/atm, and more preferably not more than 0.01 cm³/m²/day/atm.

As such a sealing film, a stacked film of an organic film and an inorganic film is preferably used. As the organic film, a polyethylene based resin, a polypropylene based resin, a polycarbonate based resin, a polyvinyl alcohol based resin and the like can be preferably used; and in particular, a polyvinyl alcohol based resin can be more preferably used. Since a polyvinyl alcohol based resin or the like has water absorbability, it is more preferable to use one prepared in an absolute dry state after subjecting to a treatment such as vacuum heating in advance. An inorganic film is accumulated on a sheet prepared by processing such a resin by coating or other method by manes of a vapor deposition, sputtering or CVD method or the like. As the inorganic film to be accumulated, silicon oxide, silicon nitride, silicon oxynitride, silicon oxide/aluminum oxide, aluminum nitride and the like are preferably used; and in particular, silicon oxide is more preferably used. For the purposes of obtaining lower water vapor permeation rate or oxygen permeation rate and preventing cracking of the inorganic film due to bending or the like, it is preferable that the formation of an organic film and an inorganic film is repeated or that a plural number of organic films having an inorganic film accumulated thereon are stuck via an adhesive layer to form a multilayered film. A thickness of the organic film is preferably from 5 to 300 μm, and more preferably from 10 to 200 μm. A thickness of the inorganic film is preferably from 10 to 300 nm, and more preferably from 20 to 200 nm. A thickness of the accumulated sealing film is preferably from 30 to 1,000 μm, and more preferably from 50 to 300 μm.

When an EL cell is sealed by this sealing film, the EL cell may be sandwiched by two sealing films, the surroundings of which are then joined and sealed; and a single sealing film may be folded two, the overlapping portion of which is then joined and sealed. As to the EL device to be sealed by a sealing film, only the EL device may be separately prepared; and the EL device can also be prepared directly on a sealing film, with the sealing film being a support.

When a sealing film with high water vapor permeation rate or oxygen permeation rate is used, it is possible to prevent the penetration of the moisture or oxygen from the sealing film surface. However, since the penetration of the moisture or oxygen from a joining portion between the sealing films is of a problem, it is desirable to dispose a drying agent layer in the surroundings of the EL cell. As the drying agent which is used in the drying agent layer, alkaline earth metal oxides such as CaO, SrO and BaO, aluminum oxide, zeolite, active carbon, silica gel, paper, resins with high hygroscopicity and the like are preferably used; and alkaline earth metal oxides are more preferable from the standpoint of hygroscopic performance. Though such a hygroscopic agent can be used even in a state of powder, for example, it is preferable to use one prepared by mixing with a resin material and processing the mixture into a sheet-like form by coating, molding or other means; or to dispose a drying agent layer by coating a coating solution having a resin material mixed therein in the surroundings of the EL cell by using a dispenser or the like. It is more preferable that not only the surroundings of the EL device but the lower surface or the upper surface of the EL cell are covered by the drying agent. In that case, it is preferable that a drying agent layer with high transparency is chosen for the surface from which light is extracted. As the drying agent layer with high transparency, polyamide based resins and the like can be used.

For the adhesion of the sealing films each other, a hot melt type adhesive or a UV-curable adhesive is preferably used; and in particular, a UV-curable adhesive is more preferable from the standpoints of water permeation rate and workability. As the hot melt type adhesive, polyolefin based resins and the like can be used; and as the UV-curable adhesive, epoxy based resins and the like can be used. In the adhesion of the sealing films each other, a method in which the adhesive is coated entirely on the sealing film, the EL cell and the drying agent layer are disposed and then stuck, and the stack is cured by heat or UV irradiation; and a method in which the EL cell and the drying agent layer are disposed in the sealing film, and the adhesive is coated in a region where the sealing films overlap each other and cured may be employed.

Though sticking of the sealing film can be achieved by a method of achieving heating or UV irradiation while applying a pressure by using a pressing machine or the like, it is more preferable to achieve the sticking by evacuating the inside of the sealing film or a sealing apparatus or in an inert gas whose dew point is controlled because the life of the EL device is enhanced.

### <Applications>

The applications of the EL device of the invention are not particularly limited, and when an application as a light source is taken into consideration, the emitting color is preferably white. As a method for making the emitting color white, for example, a method of using a phosphor particle which emits singly white light, such as a zinc sulfide phosphor particle in which copper and manganese are activated and which is gradually cooled after backing; and a method of mixing plural phosphor particles which emit light in three primary colors or in a complementary color relation are preferable (for example, a blue-green-red combination and a bluish green-orange combination). Also, as described in JP-A-7-166161, JP-A-9-245511 and JP-A-2002-62530, a method of emitting light in a short wavelength as in blue light and subjecting a part of the light emission to wavelength conversion (light emission) to green light or red light by using a fluorescent pigment or a fluorescent dye is preferable. Furthermore, as to the CIE chromaticity coordinates (x, y), it is preferable that not only the x value is in the range of from 0.30 to 0.43, but the y value is in the range of from 0.27 to 0.41.

The invention is especially effective for an application in which the EL device is made to emit light at a high luminance (for example, 600 cd/m² ox more). Concretely, the invention is effective in the case where the EL device is used under a drive condition of applying a voltage of 100 V or more and not more than 500 V between the transparent electrode and the back electrode or under a condition of driving by an alternating power source at a frequency of 800 Hz or more and not more than 4,000 Hz.

The transparent conductive film of the invention can be applied to not only a dispersion-type EL device but electrodes of display devices, for example, liquid crystal displays and electroluminescence displays, window electrodes of photoelectric convertors, for example, solar batteries, electromagnetic shielding films of electromagnetic shields, electrodes of inputting units such as transparent touch panels, and the like.

### EXAMPLES

Examples of the transparent conductive film of the invention and the EL device using this film are hereunder described, but it should not be construed that the invention is limited thereto.

### Example 1

### Transparent Conductive Film A

An Ar gas and an O₂ gas were introduced in vacuo (oxygen partial pressure: 4 to 7%) onto one surface of a transparent PET film, and an ITO thin film was formed in a thickness of 2,000 to 2,500 angstroms by a sputtering method, thereby obtaining a transparent conductive substrate having a surface resistivity of 20Ω/□.

On ITO (refractive index: 2.0) of the foregoing transparent conductive substrate, a polyester composed of bisphenol A, terephthalic acid and isophthalic acid (U POLYMER U-100 manufactured by Unitika, Ltd.) was coated as a blocking layer in a thickness of 0.08 μm, and for the purpose of improving the adhesiveness at the preparation of an EL device, an adhesive layer composed of a mixture of cyanoethyl pullulan (refractive index: 1.499) and cyanoethyl polyvinyl alcohol (refractive index: 1.494) to be used in a phosphor layer of the EL device was coated in a thickness of 0.08 μm, thereby obtaining a transparent conductive film A.

### Transparent Conductive Film B

The same procedures as in the transparent conductive film A were followed, except that a vinyl acetate resin (refractive index 1.46) was used for the blocking layer.

### Transparent Conductive Film C

The same procedures as in the transparent conductive film A were followed, except that the thickness of the polyester composed of bisphenol A, terephthalic acid and isophthalic acid was 2 μm.

### Transparent Conductive Film D

The same procedures as in the transparent conductive film A were followed, except that the thickness of the polyester composed of bisphenol A, terephthalic acid and isophthalic acid was 0.008 μm.

### Transparent Conductive Film E

The same procedures as in the transparent Conductive film A were followed, except that the thickness of the polyester composed of bisphenol A, terephthalic acid and isophthalic acid was 12 μm.

### Transparent Conductive Film F

The same procedures as in the transparent conductive film A were followed, except that the surface resistivity of the transparent conductive substrate after the ITO sputtering on PET was 150Ω/□.

### Transparent Conductive Film G

The same procedures as in the transparent conductive film A were followed, except that the blocking layer was not coated.

The thus obtained various transparent conductive films were measured with respect to a light transmittance at 550 nm. The results are shown in Table 1 along with the surface resistivity of each of the transparent conductive substrates.

TABLE 1

| | Material constituting | | | Surface resistivity of | | |
|---|---|---|---|---|---|---|
| | blocking layer | Thickness of blocking | | transparent conductive | Light transmittance at | |
| | (refractive index) | layer | | film | 550 nm | Remark |
| Transparent | Polyester composed of | 0.08 | μm | 20 Ω/□ | 91% | Invention |
| conductive film A | bisphenol A, | | | | | |
| | terephthalic acid and | | | | | |
| | isophthalic acid (1.61) | | | | | |
| Transparent | Vinyl acetate resin | ″ | | ″ | 80% | Comparison |
| conductive film B | (1.46) | | | | | |
| Transparent | Polyester composed of | 2 | μm | ″ | 87% | Invention |
| conductive film C | bisphenol A, | | | | | |
| | terephthalic acid and | | | | | |
| | isophthalic acid (1.61) | | | | | |
| Transparent | Polyester composed of | 0.008 | μm | ″ | 85% | Invention |
| conductive film D | bisphenol A, | | | | | |
| | terephthalic acid and | | | | | |
| | isophthalic acid (1.61) | | | | | |
| Transparent | Polyester composed of | 12 | μm | ″ | 84% | Invention |
| conductive film E | bisphenol A, | | | | | |
| | terephthalic acid and | | | | | |
| | isophthalic acid (1.61) | | | | | |
| Transparent | Polyester composed of | 0.08 | μm | 150 Ω/□ | 88% | Comparison |
| conductive film F | bisphenol A, | | | | | |
| | terephthalic acid and | | | | | |
| | isophthalic acid (1.61) | | | | | |

| | | | | | |
|---|---|---|---|---|---|
| Transparent | Nil | Nil | 20 Ω/□ | 75% | Comparison |
| conductive film G | | | | | |

It has been noted from Table 1 that by providing the blocking layer which meets the requirements of the invention, the reflection is reduced, whereby the light transmittance is largely enhanced; and further that in the case of using, as the blocking layer, the polyester composed of bisphenol A, terephthalic acid and isophthalic acid having a higher refractive index than cyanoethyl cellulose based resins (cyanoethyl pullulan and cyanoethyl polyvinyl alcohol) which are generally used in a phosphor layer of EL device, a higher light transmittance is obtained.

### Example 2

### EL Device A

On an aluminum electrode (back electrode) having a thickness of 100 μm, the following respective layers were formed in the order of a first layer, a second layer and a third layer, respectively by coating a coating solution for forming the layer; and furthermore, the foregoing transparent conductive film A was press bonded in a nitrogen atmosphere by using a heat roller at 190° C. such that the adhesive layer side was faced at the back electrode side and that the adhesive layer and the phosphor layer as the third layer were made adjacent each other.

The amount of each of additives in the respective layer as described below expresses a mass per square meter of the EL device.

Each of the layers was prepared by coating a coating solution whose viscosity had been adjusted by the addition of dimethylformamide and then dried at 110° C. for 10 hours.

First layer: Dielectric layer (not containing
a red light-emitting material)

| | |
|---|---|
| Cyanoethyl pullulan: | 7.0 g |
| Cyanoethyl polyvinyl alcohol: | 5.0 g |
| Barium titanate particle (average | 50.0 g |
| sphere-corresponding diameter: 0.05 μm): | |

Second layer: Dielectric layer (containing
a red light-emitting material)

| | |
|---|---|
| Cyanoethyl pullulan: | 7.0 g |
| Cyanoethyl polyvinyl alcohol: | 5.0 g |
| Barium titanate particle (average | 50.0 g |
| sphere-corresponding diameter: 0.05 μm): | |
| Fluorescent dye (having a light-emitting peak | 3.0 g |
| at 620 nm): | |

Third layer: Phosphor layer:

| | |
|---|---|
| Cyanoethyl pullulan: | 18.0 g |
| Cyanoethyl polyvinyl alcohol: | 12.0 g |
| Phosphor particle: | 120.0 g |

The preparation method and characteristics of the phosphor particle are described below.

Water was added to 150 g of ZnS (manufactured by Furuuchi Chemical Corporation, purity; 99.999%) to form a slurry, to which was then added an aqueous solution containing 0.416 g of CuSO₄.5H₂O and further added 0.0001% by mole relative to zinc of sodium chloroaurate, thereby obtaining a ZnS raw powder, a part of which was substituted with Cu (average particle size: 100 nm). To 25.0 g of the obtained raw powder, 4.2 g of BaCl₂.2H₂O, 11.2 g of MgCl₂.6H₂O and 9.0 g of SrCl₂.6H₂O were added, and the mixture was baked at 1,200° C. for 4 hours, thereby obtaining a phosphor intermediate. The foregoing particle was washed with ion exchanged water 10 times and then dried. The obtained intermediate was pulverized by a ball mill and then annealed at 700° C. for 4 hours.

The obtained phosphor particle was washed with a 10% KCN aqueous solution to eliminate excessive copper (copper sulfide) present on the surface thereof, and the residue was then washed with water 5 times, thereby obtaining a phosphor particle A. The obtained phosphor particle A had an average particle size of 17 μm and a coefficient of variation of 33%.

The transparent conductive film A (transparent electrode) was press bonded on the thus obtained coated material in the manner as described above, and an electrode terminal (aluminum plate having a thickness of 60 μm) was wired on each of the back electrode and the transparent, followed by sealing by a sealing film (polychlorotrifluoroethylene, thickness: 200 μm) to prepare an EL device A.

### EL Devices B to G

EL devices B to G were obtained in the same manner as in the EL device A, except that the transparent conductive films B to G were used, respectively in place of the transparent conductive film A.

When a voltage of 150 V was applied to each of the thus obtained EL devices by using an alternating current power source having a frequency of 1,000 Hz, in the case of defining a luminance of the EL device G as 100, a relative luminance is shown in Table 2. Also, a time after continuous lighting under the foregoing condition by using the same alternating current power source and adjusting the voltage so as to exhibit an initial luminance of 600 cd/m² until the luminance was reduced to 300 cd/m² (half-life of luminance) was examined. The results are also shown in Table 2.

TABLE 2

| | | Relative initial | Half-life of luminance under | |
|---|---|---|---|---|
| | Used transparent | luminance at 150 | a condition at an initial | |
| | conductive film | V | luminance of 600 cd/m² | Remark |
| EL device A | Transparent | 121 | 320 hours | Invention |
| | conductive film A | | | |
| EL device B | Transparent | 101 | 280 hours | Comparison |
| | conductive film B | | | |
| EL device C | Transparent | 114 | 250 hours | Invention |
| | conductive film C | | | |
| EL device D | Transparent | 113 | 240 hours | Invention |
| | conductive film D | | | |
| EL device E | Transparent | 108 | 350 hours | Invention |
| | conductive film E | | | |
| EL device F | Transparent | 115 | 180 hours | Comparison |
| | conductive film F | | | |
| EL device G | Transparent | 100 | 180 hours | Comparison |
| | conductive film G | | | |

It is noted from Table 2 that the comparison of the EL devices A, B and G reveals that A having a blocking layer with high refractive index has a high initial luminance because the reflection between the phosphor layer and the transparent thin film layer is reduced and further brings a good result in the durability because the contact between the phosphor particle in the phosphor layer and the transparent thin film layer is blocked, as compared with B and G. Also, in the comparison of the EL devices A, C, D and E, when the thickness of the blocking layer is too thin (EL device D), the blocking effect is so small that the durability-enhancing effect is small; whereas when it is too thick (EL device E), an effective electric field is not applied to the light-emitting layer, whereby the initial luminance is low.

In the EL device, in the case of using the transparent conductive film of the invention, since not only a reflection-reducing effect but plural effects including a blocking effect and an electric field effect are revealed, the thickness of the blocking layer in the invention is preferably in the range of from 0.01 to 1.5 μm.

From these results, by providing a blocking layer as in the invention, not only a transparent conductive film with high light transmittance is obtainable, but when this film is used in an EL device, an EL device having high initial luminance and high performance with good durability can be obtained.

### INDUSTRIAL APPLICABILITY

A low-resistance transparent conductive film with high light transmittance and a dispersion-type EL device with high luminance and long life using the same can be obtained.

While the invention has been described in detail and with reference to specific embodiments thereof, it will be apparent to one skilled in the art that various changes and modifications can be made herein without departing from the spirit and scope thereof.

The present application is based on a Japanese patent application, filed Jun. 30, 2005 (Japanese Patent Application No. 2005-192448), the contents of which are incorporated herein by reference.

1. A transparent conductive film comprising a transparent polymer film having on one surface thereof a transparent thin film layer with conductivity and a blocking layer containing at least one material selected from the group consisting of a thermoplastic resin, a thermosetting resin and a UV-curable resin on the thin film, wherein a surface resistivity of the transparent thin film layer with conductivity is 0.1Ω/□ or more and not more than 100Ω/□; and a refractive index of the material constituting the blocking layer is 1.6 or more and less than 1.9.

2. The transparent conductive film according to claim 1, wherein a thickness of the blocking layer is 0.01 μm or more and less than 1.5 μm.

3. The transparent conductive film according to claim 1 or 2, wherein a surface resistivity of the transparent thin film layer with conductivity is 1Ω/□ or more and not more than 85Ω/□.

4. A dispersion-type electroluminescence device comprising at least a phosphor layer between a transparent conductive film and a back electrode, wherein the transparent conductive film is the transparent conductive film according to any one of claims 1 to 3.
